(19) United States
(12) Patent Application Publication
(10) Pub. No.: US 2009/0189771 A1
(43) Pub. Date: Jul. 30, 2009

(54) SMART CARE SYSTEM

(76) Inventor: Chia-Lun LIU, Taipei Hsien (TW)

Correspondence Address: Joe McKinney Muncy, PO Box 1364, Fairfax, VA, 22038-1364, US

(21) Appl. No.: 12/021,148

(22) Filed: Jan. 28, 2008

(51) Int. Cl. G08B 23/00

(52) U.S. Cl. 340/573.1

(57) ABSTRACT

A smart care system utilizes an information collecting unit to obtain information of a care receiver from a monitoring area so as to produce a monitoring signal. The monitoring signal is transmitted to an outputting device for displaying the information collected by the information collecting unit to a care giver. The smart care system includes an identifying unit, which is set to have an identifying area corresponding to the information collecting unit for obtaining the monitoring signal so as to detect the variation thereof in the identifying area, thereby accordingly outputting a warning signal to drive the outputting device to output warning information, such that the care giver can notice the variation of the monitoring signal for coping therewith. Therefore, the problem that the care giver can not accurately and immediately realize the real situation and information of the care receiver can be solved.

### FIELD OF THE INVENTION

The present invention is related to a care system, and more particularly to a smart care system which can warn the care giver as the information or state of the care receiver varies.

### BACKGROUND OF THE INVENTION

The traditional care method is achieved by the care giver accompanying the care receiver 24 hours a day for coping with emergency. However, this kind of care method consumes a lot of manpower and cost, so that a care device (such as baby monitor) is developed for replacing the traditional way. The care device always has a camera and a player, wherein the camera is used to record the image of the care receiver, and then, the image is transmitted to the player at the care giver's side, so that the care giver can remotely realize the situation of the care receiver without accompanying at the care receiver's side. But, in practice, since the care giver actually can not keep an eye on the monitor all the time, some emergent situations (such as asphyxia, shock) might not be noticed immediately, which might cause irretrievable tragedy.

For avoiding the situation described above, a care device which can make alarm to notify the care giver is developed, as disclosed in R.O.C. Patent No. M274603, entitled “Wireless care device for detecting kicked-off blanket and smoke”. The device includes a signal sensor, a signal transceiver, and a monitor, wherein the signal sensor has a thermal sensor and an infrared emitter for emitting sensor signal, the sensor transceiver has an infrared receiver for receiving the sensor signal, a camera and a wireless transmitter for synchronously sending out the received sensor signal and the data taken by the camera, and the monitor has a radio receiver and a speaker, so that except for displaying the data taken by the camera, the monitor also can receive the sensor signal transmitted from the signal transceiver. When operation, the signal sensor is disposed on a care receiver (such as a child) for detecting the temperature around the care receiver, and if the blanket is kicked off the thermal sensor can immediately detect the temperature drop so as to send out the sensor signal, which is transmitted by the signal transceiver to the monitor, such that the care giver can have the alarm from the speaker of the monitor. However, the signal sensor actually can not reflect the real situation since the signal sensor itself might still be covered even though the blanket is kicked off.

Currently, the care device in the market only has video function, and the accuracy for detecting kicked-off blanket and smoke is still improvable. Besides, the functions provided thereby are still insufficient in detecting other situations that the care receiver might happen, for example, wake up detection, turn over detection, asphyxia detection as mouth and nose are covered, or detection of the care receiver being out of monitoring, so that the care giver still has to keep an eye on the monitor for coping with the emergency. Thus, it not only can not accurately detect the unusual situation, but also can not share the labor of the care giver, so that there is still room for improvement.

### SUMMARY OF THE INVENTION

The object of the present invention is to provide a care system which, except for viewing the movements of the care receiver, also can identify different situations of the care receiver for sending out different alarms, so that the care giver can realize the variations or unusual situations of the care receiver through the alarm without staying aside the care receiver all the time.

For achieving the object described above, the present invention provides a smart care system including an information collecting unit, an identifying unit and an outputting device. The outputting device includes a display unit and an alarm unit. The information collecting unit is set to have a monitoring area for obtaining information of the care receiver so as to produce a monitoring signal. The display unit receives the monitoring signal and outputs the information collected by the information collecting unit to a care giver. The identifying unit obtains the monitoring signal for detecting the variation thereof in the identifying area, so as to accordingly output a warning signal to drive the alarm unit to output warning information, such that the care giver can notice the variation of the monitoring signal for coping therewith.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing the architecture of the present invention;

FIG. 2 is a schematic view showing the other architecture of the present invention;

FIGS. 3A˜3D are schematic views showing a first preferred embodiment of the present invention; and

FIGS. 4A˜4C are schematic views showing a second preferred embodiment of the present invention.

### DESCRIPTION OF THE PREFERRED EMBODIMENT

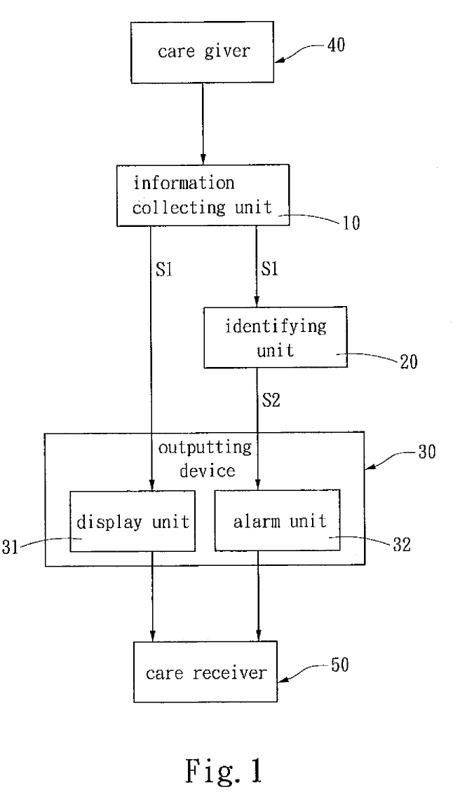

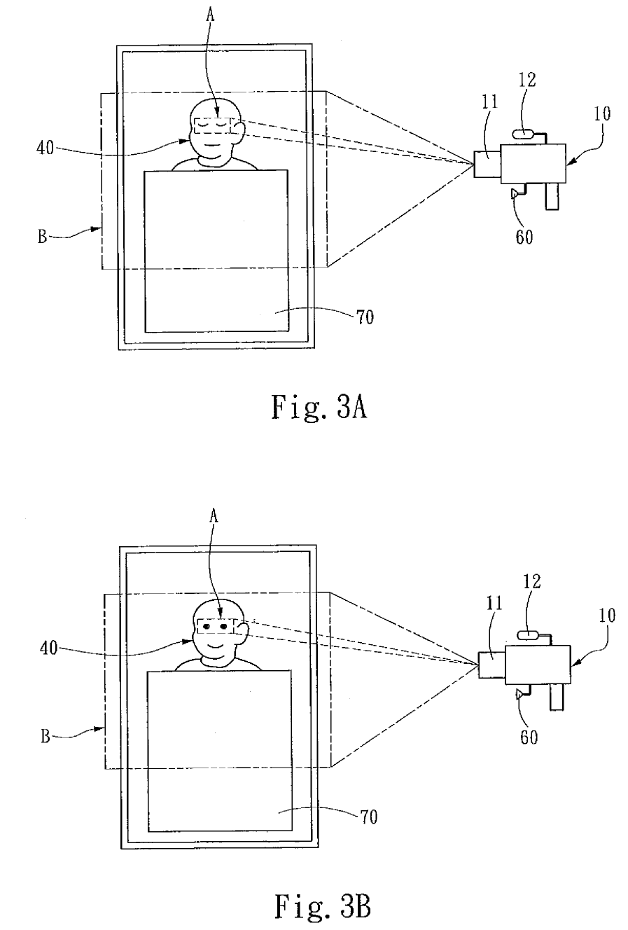

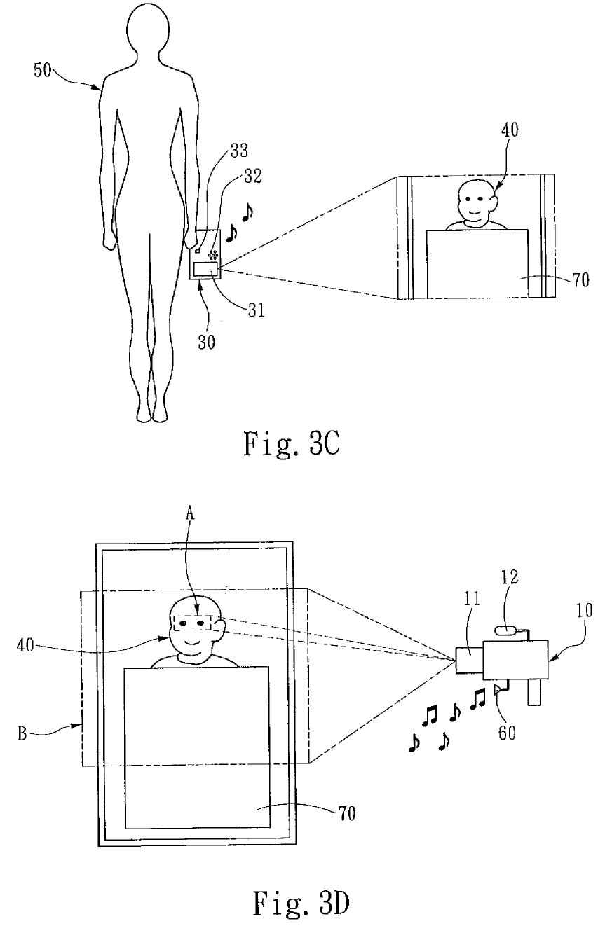

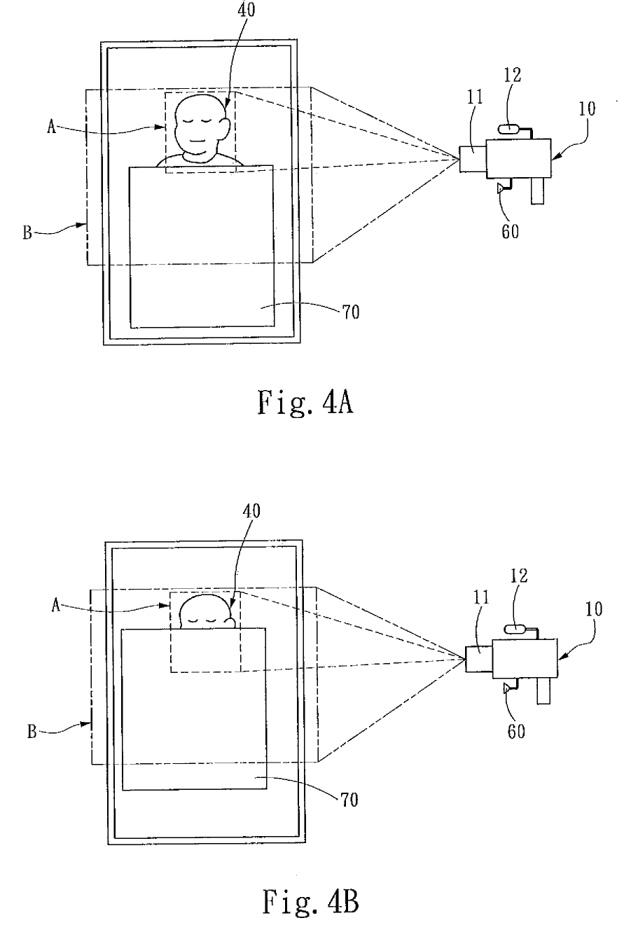

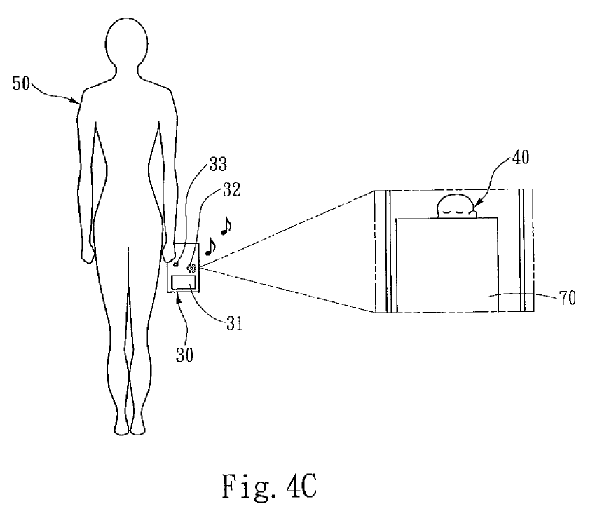

Please refer to FIG. 1. A smart care system according to the present invention includes an information collecting unit 10, an identifying unit 20, and an outputting device 30. The information collecting unit 10 is a camera with a lens 11 and a microphone 12, and the camera is set to have a monitoring area B (as shown in FIG. 3A), so that it can monitor a care receiver 40 (such as baby, elder and patient) within this monitoring area B for obtaining the information thereof, thereby producing a monitoring signal S1, for example, image information, audio information or a combination information of the care receiver 40. Besides, the monitoring signal S1 may further include environmental information of the monitoring area B, such as the body temperature of care receiver 40 or the environmental temperature therearound. The outputting device 30 is a mobile electronic device capable of being carried by the care giver 50, such as a multimedia player device, a mobile phone, and a PDA, and includes a display unit 31 and an alarm unit 32. The display unit 31 receives the monitoring signal S1 and outputs information of the care receiver 40 to the care giver 50, and the alarm unit 32 can be a buzzer, a warning light or a vibration motor built in the mobile electronic device. Furthermore, the identifying unit 20 is disposed in the camera with movement detecting system, audio detecting system and thermal sensing system for detecting the monitoring signal S1, and is set to have an identifying area A (such as the head or eyes portion of the care receiver 40, as shown in FIG. 3A and FIG. 4A). Here, the identifying unit 20 obtains the monitoring signal S1 for detecting the variation thereof in the identifying area A, so as to accordingly output a warning signal S2. After receiving the warning signal S2, the alarm unit 32 alerts the care giver 50 through sounds, light or vibration, such that the care giver 50 can notice the variation of the monitoring signal S1 at the first time. Then, through the outputting device 30, the care giver 50 can receive the notice and can check the information obtained by the information collecting unit 10, so as to react properly.

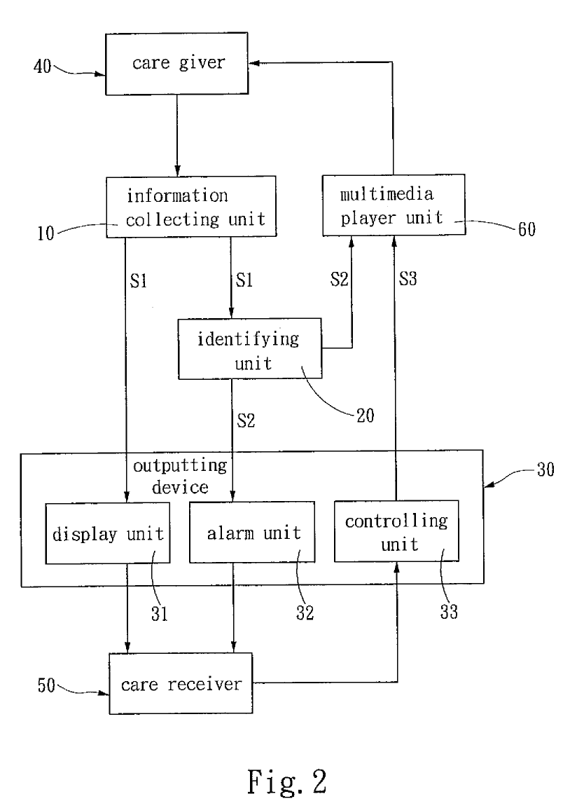

Besides, as shown in FIG. 2, the smart care system according to the present invention can further include a multimedia player unit 60. The multimedia player unit 60 is connected with the identifying unit 20, and will be driven by the warning signal S2 to play video or audio signal for the care giver as the monitoring signal S1 varies. Moreover, the outputting device 30 of the present invention further includes a controlling unit 33, so that the care giver 50 can output a controlling signal S3 through the controlling unit 33 to the multimedia player unit 60, thereby achieving an automatic control to the multimedia player unit 60.

When implementing the present invention, the identifying unit 20 can set the identifying area A to be a specific portion in accordance with the situation to be detected. As shown in FIG. 3A, the identifying area A can be set to be the eyes of the care receiver 40 for detecting the image variation of the eyes, so as to judge if the care receiver 40 wakens. In FIG. 3A, originally, the care receiver 40 is sleeping, and then, when the care receiver 40 wakes up and the eyes open(as shown in FIG. 3B), the identifying unit 20 can detect the image variation of eyes of the care receiver 40 so as to output the warning signal S2, and the alarm unit 32 of the outputting device 30 will be driven by the warning signal S2 to output alarm, as shown in FIG. 3C, so as to notify the care giver 50 the awake state and the opened eyes of the care receiver 40. Furthermore, the wakened care receiver 40 might cry or make noises, through driving the multimedia player unit 60 by the controlling unit 33, the care giver 50 can output the image or sound thereof first, so as to pacify the care receiver 40, or the identifying unit 20 can be set to automatically drive the multimedia player unit 60 (as shown in FIG. 3D).

Except for detecting the eye area of the care receiver 40, the identifying unit 20 also can set the identifying area A as the head portion of the care receiver 40, as shown in FIG. 4A to FIG. 4C. If the mouth and nose of the receiver 40 are covered by the blanket 70, which means the blanket 70 has been moved and invaded the identifying area A, then through the identifying area A, the identifying unit 20 can detect the image variation of the care receiver's head, so as to output the warning signal S2 to the alarm unit 32 of the outputting device 30 for warning the care giver 50, such that the care giver 50 can check the situation of the care receiver 40 through the display unit 31 first. In addition, the identifying unit 20 also can produce the warning signal S2 in different degrees in accordance with the variation degrees of the identifying area A, so that the alarm unit 32 can correspondingly produce alarms in different degrees (such as the volume magnitude of buzzer, the flash frequency of warning light, or the vibration magnitude of vibration motor). For example, if the mouth and nose of the care receiver 40 is covered by the blanket 70, which means asphyxia might happen, the monitoring signal S1 can produce a more serious variation in the identifying area A, so that the identifying unit 20 can produce a warning signal representing the more emergent situation. Then, the alarm unit 32 can output the alarm corresponding to the degree of the warning signal S2, so that the care giver 50 can identify the degree of emergency according to the alarm.

Except for the embodiments described above, the identifying unit 20 also can set the identifying area A as other specific areas for processing other detections, for example:

Blanket kicked-off detection: If the blanket 70 has moved in the identifying area A so as to expose the body of the care receiver 40, then the outputting device 30 outputs alarm.

Body turned-over detection: If the care receiver 40 turns the body over, the outputting device 30 outputs alarm to notify the care giver 50.

Out-of-monitoring detection: The covering area of the identifying area A can be adjusted to be identical to the monitoring area B, so that when the care receiver 40 is out of the identifying area A (such as the playing area of the care receiver 40), the outputting device 30 can output alarm to notify the care giver 50.

In the aforesaid, in the smart care system according to the present invention, through the information collecting unit 10, the information of the care receiver 40 can be provided to the care giver 50. Moreover, the information obtained by the information collecting unit 10 can be identified by the identifying unit 20 for realizing that if the identifying area A has varied, so that at the very first time the information varies, the alarm unit 32 can be driven to output alarm for notifying the care giver 50 the changed or unusual state of the care receiver 40. Therefore, not only the long term care can be prevented, a smart identification of the situation of the care receiver also can be achieved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the fill extent indicated by the broad general meaning of the terms in which the appended claims are expressed.

What is claimed is:

1. A smart care system, comprising:
an information collecting unit, set to have a monitoring area for collecting an information of a care receiver so as to produce a monitoring signal;
an identifying unit, set to have an identifying area corresponding to the information collecting unit, for receiving the monitoring signal and deciding an output of a warning signal through detecting a variation of the monitoring signal in the identifying area; and
an outputting device, including a display unit for receiving the information of the care receiver outputted by the monitoring signal, and an alarm unit for outputting alarm as receiving the warning signal.

2. The smart care system as claimed in claim 1, wherein the monitoring signal is selected from one or a combination of an image information and an audio information.

3. The smart care system as claimed in claim 2, wherein the monitoring signal further comprises an environmental information within the monitoring area.

4. The smart care system as claimed in claim 1, wherein the monitoring signal further comprises an environmental information within the monitoring area.

5. The smart care system as claimed in claim 1, wherein the information collecting unit is a camera with a lens and a microphone.

6. The smart care system as claimed in claim 1, wherein the identifying unit is one or a-combination of a movement detecting system, an audio detecting system, and a thermal sensing system.

7. The smart care system as claimed in claim 1, wherein the alarm unit is one or a combination of a buzzer, an alarming light and a vibration motor.

8. The smart care system as claimed in claim 1, wherein the outputting device is a mobile electronic device.

9. The smart care system as claimed in claim 1, further comprising a multimedia player unit for playing multimedia information of the care receiver.

10. The smart care system as claimed in claim 9, wherein the multimedia player unit receives the warning signal and is driven thereby to produce multimedia information.

11. The smart care system as claimed in claim 9, wherein the outputting device comprises a controlling unit for outputting a control signal to the multimedia player unit so as to produce multimedia information.
